(19) United States
(12) Patent Application Publication
(10) Pub. No.: US 2006/0201951 A1
(43) Pub. Date: Sep. 14, 2006

(54) Handheld paint and application tool container

(76) Inventor: Frank Joseph Cingel, Severna Park, MD (US)

Correspondence Address: Frank J. Cingel, 109 Stauffer Rd., Severna Park, MD, 21146, US

(21) Appl. No.: 11/077,568

(22) Filed: Mar. 11, 2005

(51) Int. Cl. B05C 21/00

(52) U.S. Cl. 220/570

(57) ABSTRACT

A handheld paint container assembly with a curved handle fixed at one end, positioned for comfort over the center of gravity, and providing good control over container position when dipping paint application tools. An internal confining shelf with capacity to tote a variety of paint application tools. Ideal for applying paint with a smaller roller, and using the paintbrush to tip the rolled surfaces and to paint the areas the roller couldn't reach. It readily hangs on a ladder rung, positioned for convenient and secure access.

### REFERENCES CITED

### U.S. Patent Documents

| | | | |
|---|---|---|---|
| 1,008,856 | November, 1911 | Mosher | 401/121 |
| 2,705,334 | April, 1955 | Farrow | 15/257 |
| 2,932,838 | April, 1960 | Ouellette | 15/257 |
| 3,252,613 | May, 1966 | McGrath | 220/23 |
| 3,576,045 | April, 1971 | Stafford | 15/257 |
| 3,595,431 | July, 1971 | Bird | 220/697 |
| 4,860,891 | August, 1989 | Biggio | 206/362 |
| 4,919,298 | April, 1990 | Gregory | 270/736 |
| 4,927,046 | May, 1990 | Armstrong | 220/697 |
| 5,054,661 | October, 1991 | Hollje | 222/465 |
| 5,201,439 | April, 1993 | Davies | 220/735 |
| 5,341,969 | August, 1994 | Accardo, et al. | 222/465 |
| 5,390,888 | February, 1995 | Rogers | 248/318 |
| 5,400,916 | March, 1995 | Weber | 220/495 |
| 5,402,910 | April, 1995 | Pilney | 220/751 |
| 5,493,751 | February, 1996 | Misiukowiec, et al. | 15/257 |
| 5,546,628 | August, 1996 | Silvera | 15/257 |
| 5,549,216 | August, 1996 | Scholl | 220/695 |
| 5,634,568 | June, 1997 | Wawrzyniak | 220/510 |
| 5,810,196 | September, 1998 | Lundy | 220/736 |
| 5,836,043 | November, 1998 | Rovas | 15/257 |
| 5,971,201 | October, 1999 | Daw | 220/697 |
| 6,419,106 B1 | July, 2002 | Bebak | 220/570 |
| 6,513,771 B1 | February, 2003 | Tucker | 248/211 |
| 6,681,924 B2 | January, 2004 | Renzello | 206/15 |

### U.S. Patent Applications

| | | | |
|---|---|---|---|
| 20030204929 A1 | November, 2003 | Rougeau | 15/257 |
| 20040195248 A1 | October, 2004 | Garcia | 220/570 |
| 20040206761 A1 | October, 2004 | Frantz | 220/570 |

### Foreign Patent Documents

| | | |
|---|---|---|
| GB2137480 | October, 1984 | Brown |
| FR2646829 | November, 1990 | Rocca |
| GB2251843 | July, 1992 | Jeffries, et al. |
| GB2345897 | July, 2000 | Ward |
| GB2386362 | September, 2003 | Moore |
| WO03078179 | September, 2003 | Hildering |

This application is related to Disclosure Document No. 565547 received by USPTO Nov. 23, 2004 entitled “Handheld Paint and Spreading Tool Container”.

### BACKGROUND OF THE INVENTION

1. Field of the Invention

The present invention relates to paint containers which are carried in one hand while painting with the other. When painting trim, on a house for example, it is common practice to paint the interior walls with a large roller and paint the wood trim with a small paintbrush, and often with a different paint than that used for the walls. Outside the house the siding may not get painted, but often there is a large amount of trim to paint. Dipping a paintbrush, small roller or other application tool into a horizontal type roller tray requires frequent bending over because of the small paint capacity of these tools. The tray needs to be moved often to make it accessible, increasing the danger of spillage. Outside the house often times it is hard to find a flat surface close to the working area on which to set the tray down.

When painting with paintbrush alone it is not uncommon to either dip paint from the as purchased container or to pour some paint into a smaller container, which might be a commercial container or an empty coffee can. If the common one gallon paint can is purchased, mobility of the painter is reduced because of its awkwardness and weight, discomfort to carry, and the need to find a safe place to set it down. Trim surfaces generally consist of a combination of those suitable for small paintbrush only and slightly larger surfaces which can be painted with a small roller or one of a wide assortment of application tools.

2. Related Art

Generic paint containers used for trim and other small surfaces typically consist of a bucket suspended by a free swinging metal bail or a large plastic cup held at the bottom in the palm of the hand. Prior art has numerous containers with handles that are intended to be held in one hand while painting with the other. Many have storage areas for a paintbrush or a small roller but are unlikely to accommodate both.

Some containers have handles on one side such that they are carried much like a coffee mug, which is tiring, and awkward to pick up and set down on a floor. Examples of this type of container are: U.S. Pat. Nos. 4,860,891, 4,927,046, 5,054,661, 5,549,216, 5,971,201, 6,419,106, 6,513,771, and Patent Applications US 2004/0206761 and US 2004/0195248, and foreign patents WO03078179 and GB2251843. When storing a paintbrush many paint containers rely on the paintbrush having a certain configuration or overall size. Examples of this type are: U.S. Pat. Nos. 1,008,856, 3,252,613, 4,860,891, 4,919,298, 5,390,888, and 6,681,924. Some paint containers are modifications of the swinging bail bucket which are uncomfortable to carry and give poor control over bucket position when dipping the paint application tools. Examples of this type are: U.S. Pat. Nos. 2,705,334, 2,932,838, 3,595,431, 5,341,969, 5,402,910, 5,400,916, 5,810,196 and foreign patent FR2646829. Some paint containers are designed specifically for use on a ladder, some have that included purpose and some cannot be safely used on a ladder.

### SUMMARY OF THE INVENTION

The HANDHELD PAINT AND APPLICATION TOOL CONTAINER, according to the present invention, is generally designed to permit being carried for long periods of time and give the painter freedom to move about without being encumbered by a large paint bucket or a flat horizontal type roller tray while painting trim and other relatively small surfaces. The container is designed to tote an assortment of paint application tools internal to the container, such as a roller and/or paintbrush, or a large and small paintbrush, along with a supply of paint. With this invention the painter can roll the surfaces that are suitable for the roller or other tool being used and finish the areas the larger tool won't reach with the paintbrush. This is a faster process than using a paintbrush alone for trim. Smoothing the rolled surface with the tip of the paintbrush is sometimes desirable to obtain a preferred finish.

A carrying handle open at one end is rigidly affixed to the back wall and rises in a smooth curve to a horizontal position over the center of gravity of the container. The handle affords a comfortable grip. Allowing the weight of the container with paint to hang down vertically from the hand is least tiring for all day painting. A rigid curved handle allows one to shift the hand back down the handle in order to tilt the container as needed with one hand while dipping and wiping the paintbrush with the other hand, or while dipping and squeezing the roller. A curved handle also permits tilting the container to access the last of the paint and to easily pour with one hand the contents from a corner of the container.

A shelf is mounted internally near the back wall for the purpose of toting paint application tools. The shelf has confining vertical surfaces and preferably extends from one side of the container to the other horizontally such that it is parallel to the back wall. There is sufficient open space to allow excess paint to flow back into the main reservoir and the shelf width is dimensioned to accommodate an assortment of painting tools.

A rest for the roller's handle is provided at the upper edges of the left and right side walls when the tool's roller sleeve end is resting on the shelf. This provides stability for the handle by preventing it from sliding back and forth as the container is carried.

Raised protrusions on the inside of the container's front wall helps the roller to rotate when squeezing excess paint, distributing it evenly on the roller sleeve surface.

An object of this invention is to provide an improved paint container which will hold an adequate amount of paint for the job at hand, be comfortable to carry for hours at a time, provide a means to tote a variety of paint application tools, be securely supported when working from a ladder, and allow for easy cleaning.

A further object is to facilitate container construction which is susceptible of a low cost of manufacture. Such an embodiment might include an owner installed handle and shelf which allows nested stacking of the containers to reduce shipping and storage expenses. A removable shelf also allows for a more thorough paint cleanup after job completion.

### DESCRIPTION OF THE DRAWINGS

Referring to the drawings, illustrating a preferred embodiment of this invention:

FIG. 1 is a left side perspective view of the container main parts and features.

FIG. 2 is a perspective view from a frontal direction which additionally shows one of several intendments for the placement of two common paint application tools and a ladder hook.

FIG. 3 is a plan view of the container.

FIG. 4 is a left side view of the container

FIG. 5 is a right side view of the container which additionally shows the intendments when attached to a ladder.

FIG. 6 is a perspective assembly view of the shelf and the side wall protuberances.

### DETAILED DESCRIPTION OF THE INVENTION

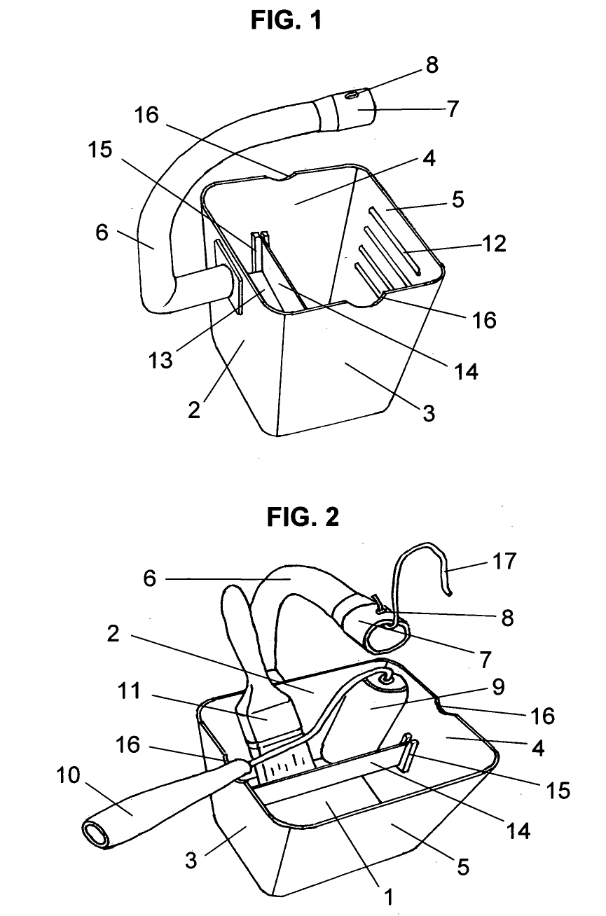

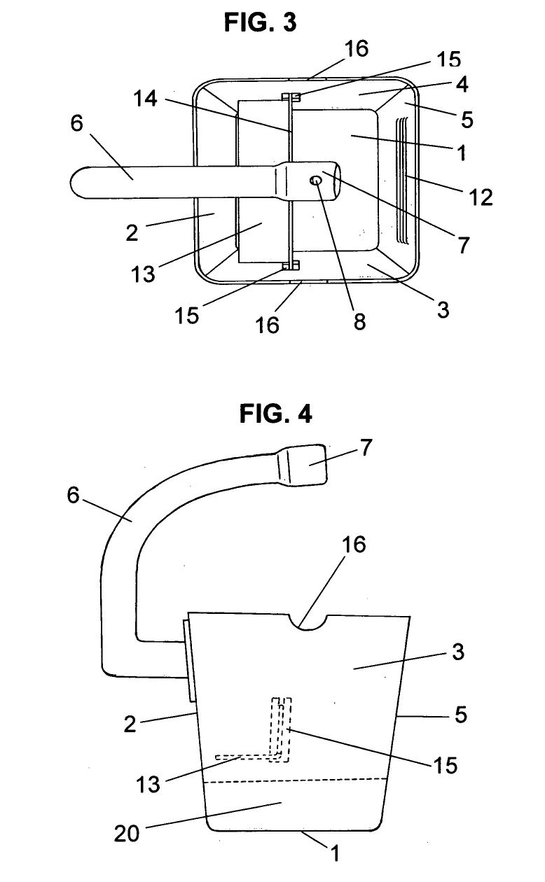

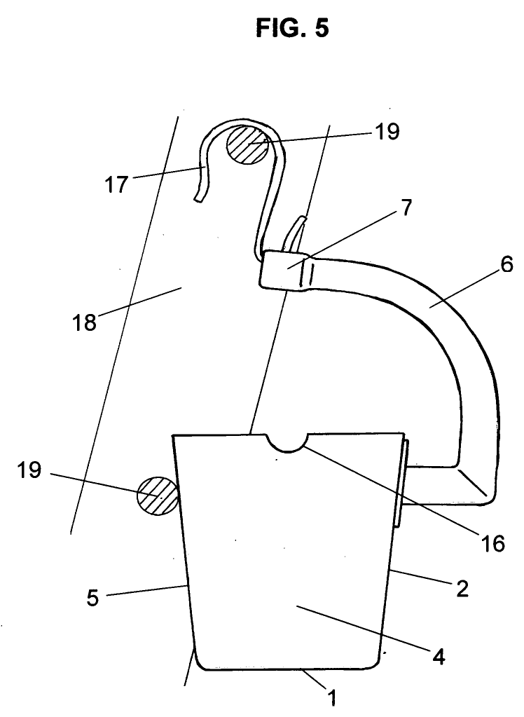

Referring to FIGS. 1-6 there is shown the preferred embodiment of the invention, attention being called to the fact, however, that the drawings are illustrative only, and that changes may be made in the specific construction illustrated and described, within the scope of the appended claims.

The preferred container comprises a generally rectangular or square base plate with side walls of equal height that slope outward from the bottom base plate 1, to the top. The base plate 1, back wall 2, left side wall 3, right side wall 4, and front wall 5 are all connected to define an interior volume. Radii adjacent to the base plate are small to increase the contact area of the footprint but large enough to facilitate cleaning paint from the bottom corners of the container. Radii between sides, front, and back walls are more generous for the purpose of pouring unused paint from the container and to provide nesting for the paint roller sleeve 9 of the paint roller assembly.

The carrying handle 6, one end of which is rigidly affixed to the horizontal center of the back wall 2, is stepped back outwardly from the wall to provide clearance for working the painting tools, rises vertically, then curves smoothly to a position where it terminates unattached, approximately horizontal and over the center of gravity of the container, and at a height which provides a good working clearance above the sides of the container. The handle is fastened to the container by screws through a flange, but there are many possibilities, and the method is best determined by manufacturing economics, designed with consideration for nested stacking of containers for shipping and storage. The handle 6 is of large enough diameter and shape to provide a comfortable grip, and is positioned such that when painting, the hand is approximately over the center of gravity of the paint container. A knob 7 at the unattached end facilitates a non-slip grip. For working from a ladder 18, the unattached end of the handle has a receptacle, or hole 8, for receiving a metal hook 17, typically S-shaped, for attachment to a ladder rung 19. The hook is designed to place the container conveniently in front of the painter, resting against the ladder rung below, providing easy access and stability.

The front wall 5, opposite the handle attachment point, has a plurality of protrusions 12, usually in the form of ripples, corrugations or raised dimples on the inside surface sufficient to cause the roller sleeve 9 to rotate when squeezing and distributing the paint across the sleeve. Without the protrusions the roller sleeve tends to slide across the surface making it difficult to squeeze the paint. The protrusions also provide a surface to wipe other paint application tools being used.

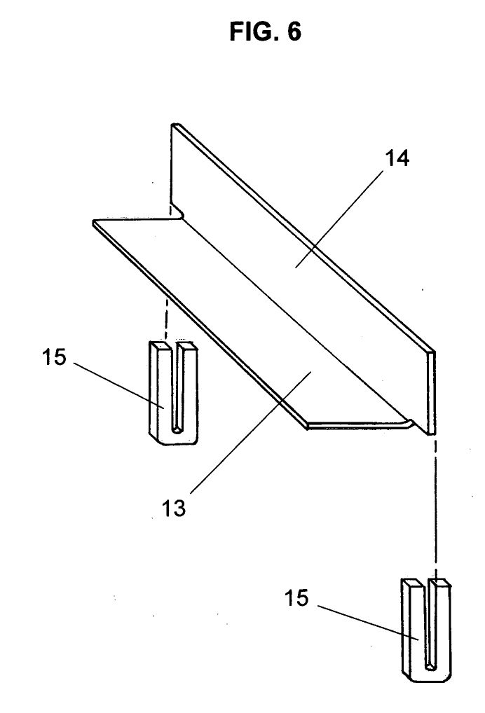

A shelf 13 with encompassing vertical surfaces is mounted internal to the container for the purpose of toting paint application tools. The shelf is adjacent and parallel to the back wall 2, angular in shape with one side of the angle forming a vertical rising sidewall 14, the other confining vertical surfaces being formed by the adjacent back wall 2 and the left 3 and right 4 side walls of the container. The shelf 13 is positioned at a height such that it is above the paint 20 contained within the paint reservoir, allowing for a capacity of one quart or more. Shelf width and depth are dimensioned to accommodate the painting tools for which it is intended and to allow practical insertion and removal of the tools. Generally, width is determined by the outside diameter of the largest intended roller sleeve, as the sidewall 14 helps to support the roller sleeve on its end. This width also will provide a stable resting place for the paintbrush 11 with its bristles in the corner between the shelf and its vertical sidewall 14. There is sufficient open space to allow excess paint to flow back into the main reservoir. This is created by a gap around the unsupported portion of the shelf's perimeter or optionally by cutouts in the shelf. The upper edge of the vertical sidewall 14 provides an additional surface internal to the container which is convenient for wiping the paintbrush 11 and other paint application tools, avoiding dripping paint on the outside of the container which in turn has a tendency to apply paint where it wasn't intended. The shelf 13 is supported by the vertical sidewall 14 which in turn is supported at its ends by protuberances 15 attached to, or a part of, the left 3 and right 4 sides of the container in such a manner so as to allow the shelf to be readily removed and reinstalled for the purposes of cleaning and stacking. Shown on the drawings are protuberances with U-shaped vertical slots which accept the right and left ends of the vertical sidewall 14, allowance being made for the shelf 13 to clear the protuberances 15. FIG. 6 shows assembly of the shelf and protuberances which are shown removed from the container sides for clarity.

An incurved depression 16 is formed near the top edge of the left 3 and right 4 side walls, dimensioned for the purpose of resting a paint roller handle 10 when the tool's roller sleeve 9 is resting on the shelf 13, to keep it from sliding back and forth when toting. Handle rests 16 are located on both sides of the container for left and right hand painting, approximately mid way between the back wall and the front wall. It is to be realized that additional similar configurations located on the side walls, for the purpose of stowing various paint application tools, are intended to be encompassed by this invention.

Although paint is the reference application liquid used to describe this invention, it will be understood that the container's usefulness also extends to the application of other liquids such as varnish, lacquer, stain, and epoxy, intended to be applied to a surface with the tools of the type utilized herein.

Preferred material of construction is plastic with metal used as needed to secure a sturdy assembly.

The invention claimed is:

1. A painters handheld liquid container comprising:
(a) a container body having a base plate and plurality of vertical walls defining an open top cavity for receiving paint,
wherein one wall, defined as the front wall, is adapted and dimensioned internally to be a paint roller squeeze surface; and
(b) a carrying handle providing an ergonomically comfortable grip, is positioned such that when painting, the hand is approximately above the center of gravity of the paint container, and is at a height sufficient to provide working clearance around the container sides,
wherein said handle, one end of which is rigidly affixed to the back wall, opposite the front wall, lies in a plane which passes through the center of the front wall and which is perpendicular to the base plate and the front wall, rises vertically, then curves smoothly to assume an approximately horizontal position above the container, the other end of the handle remaining unattached; and
(c) an internal shelf mounted in front of and near the back wall, enhanced by encompassing near-vertical sidewalls,
wherein said shelf is positioned at a height sufficiently above the base plate to provide space to contain paint within the paint cavity reservoir, and the height of the sidewall top above the shelf and the shelf length and width are dimensioned so as to accommodate and contain the intended painting tools, there being adequate opening for excess paint to drain to the reservoir below.

2. The container of claim 1 wherein one or more container walls are sloped outwardly from the base plate to the opening at the top.

3. The container of claim 1 wherein the paint roller squeeze surface internally of the front wall consists of a plurality of protrusions.

4. The container of claim 1 wherein the base plate is generally rectangular in shape.

5. The container of claim 1 wherein the upper edges of either the left or the right container side walls, as seen facing the front wall, incorporate a paint roller handle rest, dimensioned to accommodate the handle of a paint roller tool, keeping it from sliding when the container is hand carried, and the roller sleeve end is resting on the shelf.

6. The container of claim 5 wherein the handle rest consists of an incurved depression at the top edge of either the left or right side walls of the container.

7. The container of claim 6 wherein there are handle rests on both side walls.

8. The container of claim 1 wherein the carrying handle has a receptacle near its unattached end for the purpose of receiving a device designed for the purpose of hooking onto the rung of a typical ladder, supporting the container for convenient access and stability when painting from the ladder.

9. The container of claim 1 wherein the carrying handle is rigidly affixed to the horizontal center of the back wall, is stepped back outwardly from the wall to provide clearance for working the painting tools, rises vertically, then curves smoothly to a position where it is approximately horizontal.

10. The container of claim 1 wherein the unattached end of the handle includes a knob.

11. The container of claim 1 wherein the shelf is supported in such a manner so as to permit removal and reinstallation by the user.

12. The container of claim 1 wherein the shelf is adjacent to, and parallel to, the back wall, has encompassing sidewalls, is angular in form with one side of the angle defining a vertical rising sidewall internal to the container, and the remaining sidewalls being formed by the container walls.

13. The container of claim 12 wherein the shelf is supported by protuberances located internally on the right and left sides of the container which have a U-shaped vertical slot designed to accept each end of the shelf's internal vertical sidewall, allowing for removal and reinsertion of the shelf.
